(19) United States
(12) Patent Application Publication
(10) Pub. No.: US 2015/0338040 A1
(43) Pub. Date: Nov. 26, 2015

(54) LIGHTING DEVICE

(71) Applicant: Karl T. Swope, Reno, NV (US)

(72) Inventor: Karl T. Swope, Reno, NV (US)

(21) Appl. No.: 14/717,610

(22) Filed: May 20, 2015

Related U.S. Application Data
(60) Provisional application No. 62/000,732, filed on May 20, 2014.

(51) Int. Cl. F21S 8/08; F21V 5/08; F21V 13/04; F21V 23/00; F21S 9/03; F21V 5/00; F21V 7/04

(52) U.S. Cl. CPC F21S 8/083; F21V 5/002; F21V 5/008; F21V 5/08; F21V 7/041; F21V 23/009; F21S 9/037; F21V 13/04

(57) ABSTRACT

A post cap light includes first and second lenses around a light source. The light source may be powered by batteries, an external supply or by an integrated solar panel. The first lens and second lenses may provided different lighting effects to light emitted from the light source. The first lens may be a faceted lens while the second lens, external to the first lens, may include vertical flutes, grooves and ridges. An internal reflector may reflect downward projecting light sideways through the second lens.

### CROSS REFERENCE TO RELATED APPLICATIONS

This application claims priority to U.S. provisional patent application Ser. No. 62/000,732, filed 20 May 2014, the contents of which are herein incorporated by reference.

### FIELD OF THE INVENTION

The present invention relates to lighting products in particular, though not exclusively, for decorative lighting.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide enhanced lighting effects;

provide a number of different lighting effects; and

provide an aesthetic lighting device.

These and other advantages may be realized by reference to the remaining portions of the specification, claims, and abstract.

### BRIEF DESCRIPTION OF ONE EMBODIMENT OF THE PRESENT INVENTION

In one aspect, the invention provides a post cap light comprising a housing, a light source, a first lens around the light source, and a second lens around the first lens.

In one embodiment, the second lens may have an open end and a reflector may be disposed at the open end to reflect light from the light source away from the open end of the second lens.

In one aspect, there is provided a post cap light including light source means. First lens means may alter light from the light source means and a second lens means may alter light from the light source and/or the first lens means.

In one aspect, there is provided a post cap light comprising a light source, a first lens, a second lens and a housing. The housing may be supported by a post. The first lens may comprise one of a faceted lens or a lens comprising one or more grooves, ridges or flutes and the second lens may comprise the other of a faceted lens or a lens comprising one or more grooves, ridges or flutes to thereby impart two different lighting effects to the light emitted from the light source.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially an exploded view of a post cap light;

FIG. 2 is substantially a side schematic showing the internal components of the post cap light

FIG. 3 is substantially a side view of the lighting device of FIG. 1;

FIG. 4 is substantially a perspective view of the post cap light of FIG. 1;

FIG. 5 is substantially an exploded view of an alternative post cap light;

FIG. 6 is substantially a side view of the post cap light of FIG. 4;

FIG. 7 is substantially a perspective view of the post cap light of FIG. 4;

FIG. 8 is substantially an exploded view of an alternative post cap light;

FIG. 9 is substantially a side view of the post cap light of FIG. 7;

FIG. 10 is substantially a perspective view of the post cap light of FIG. 7;

FIG. 11 is substantially an exploded view of an alternative post cap light;

FIG. 12 is substantially a side view of the post cap light of FIG. 10;

FIG. 13 is substantially a perspective view of the post cap light of FIG. 10.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

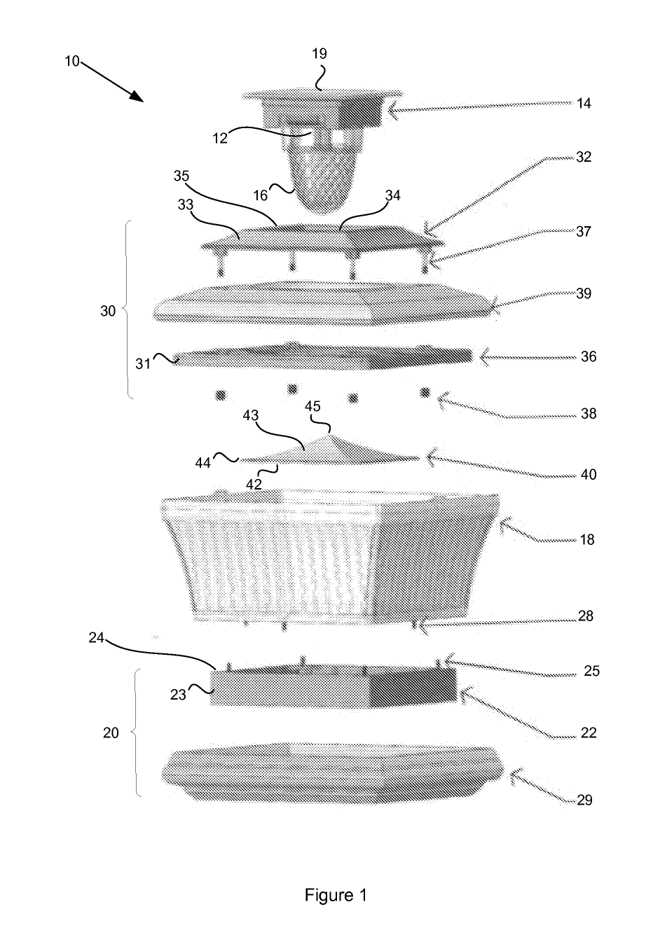

The present invention comprises a post cap light generally indicated by reference number 10 in FIG. 1, which is an exploded view of the lighting device 10. At the core of the lighting device 10, there is a light source 12 surrounded by a first lens 16. The light source 12 may be one or more LEDs, bulbs, or other suitable light sources as the person skilled in the art may determine. The light source 12 may be connected to a power source 14. In the embodiment of FIG. 1, the power source 14 may include a solar panel or photovoltaic element 19 and associated electronics that converts sunlight into electrical energy which is then provided to the light source 12 through appropriate electrical connections, wiring, etc. In an alternative embodiment, the power source 14 may include a battery which may be rechargeable through a recharging port or may be a replaceable battery housed within a battery compartment that can be accessed externally for battery replacement. In a further alternative, the power source may be an external power supply such as an external battery, solar panel, generator or mains supply that connects to the light source 12 through appropriate wiring.

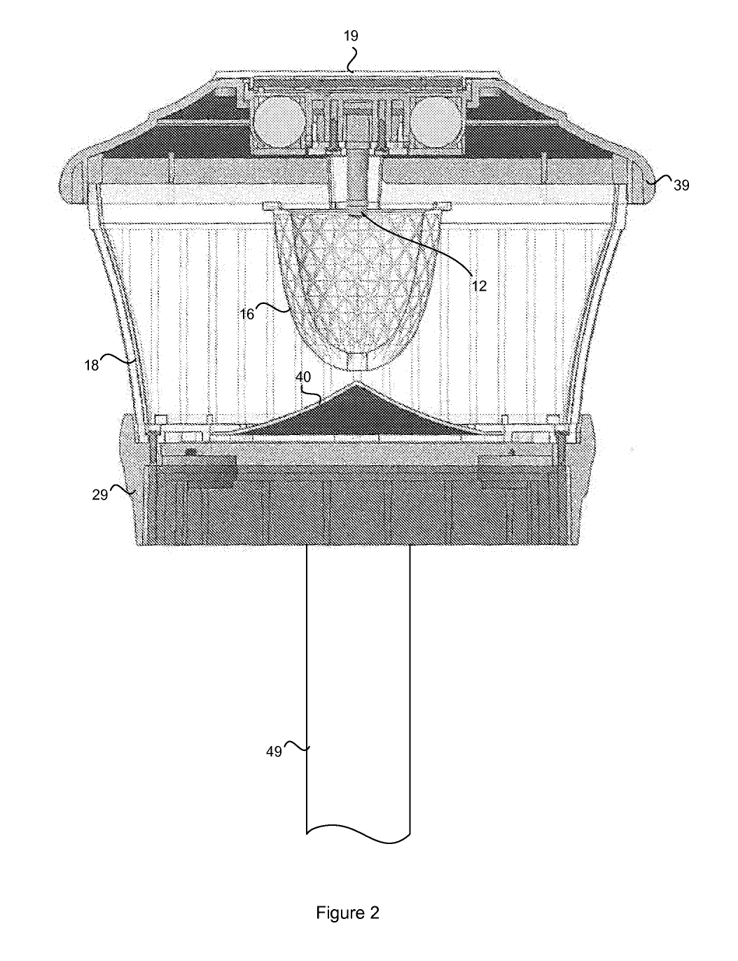

FIG. 2 shows the assembled post cap light with the inner workings of the power source and associated electronics. The light source 12 may include one or more LEDs, bulbs etc.

Covering the light source 12 is a first lens 16. The first lens 16 may be a dome lens. The first lens 16 may have facets, ridges and/or 3D patterns that refract light or otherwise alter light from the light source 12 to assist in the creation of a first lighting effect. The first lighting effect may be a sparkle effect. The first lens may connect to the power source assembly 14 by any suitable connections, such as a bayonet fitting, screw threads, press tabs, etc. The power source assembly 14 may support the first lens 16 below the power source assembly 14.

Surrounding the first lens 16 may be a second lens 18 designed to create a second lighting effect. For example, the second lens 18 may have vertical fluting that refracts light that alters light from the light source and/or first lens. In one embodiment, the second lens 18 is a lenticular lens.

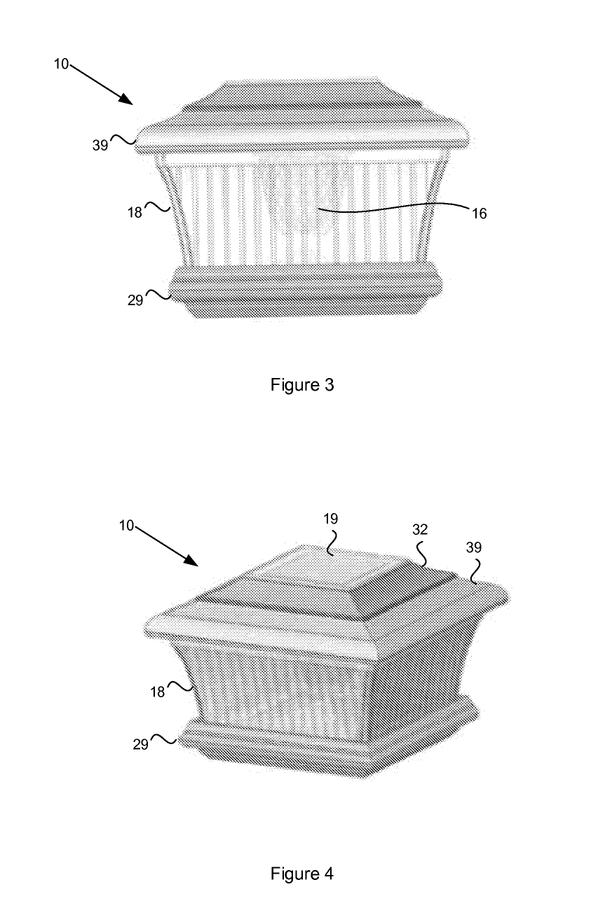

The light source 12, power source 14 and lenses 16, 18 may be mounted via a multiple piece housing. The multi-piece housing may include a lower portion 20 and an upper portion 30. The lower portion 20 may include a lower ring 22 having a peripheral wall 23. On a top side 24 of the peripheral wall there may be one or more pegs, dowels, etc. 25 that extend upwardly and are received into recesses in the second lens 18. Similarly, the second lens may include one or more pegs, dowels, etc. 28 that extend downwardly and are received into recesses in the top of the peripheral wall 24. In alternative embodiments, the pieces 25 may be threaded and the receiving recesses may be similarly threaded to allow screw fit attachment of the second lens 18 to the lower ring 22. The lower housing assembly 20 also includes a base plate 29 that receives the lower ring 22 into a recess thereof and conceals the junction of the lower ring 22 with the second lens 18, as depicted in FIGS. 2 and 3, thereby increasing the decorative appearance of the lighting device 10. The lower ring may be retained in the base plate 29 by screws, adhesives, snap fittings, etc.

The upper housing assembly 30 of the housing includes an upper ring 36 having a peripheral wall 31. The upper ring 36 may be used to secure the upper housing portion 30 to the second lens 18. The upper housing assembly 30 also includes a top cap 32 that has an upper external surface 33 forming an outer upper surface of the housing. The top cap 32 includes an aperture 34 defined by an inner rim. The rim 35 includes an inner shelf or ledge on which the solar panel 19 can rest. The solar panel 19, light source 12 and first lens 16 may be preassembled and lowered into the aperture until resting on the lower rim. The upper surface of the solar panel 19, being the photovoltaic or solar collecting element, sits flush with the top cap and is thus exposed above the housing in a position to receive sunlight. The solar cell 14 may be glued to the upper ring 36 with suitable adhesive, such as a silicon glue. Other methods of attachment will be apparent to the person skilled in the art. In an alternative embodiment, instead of resting within the top 32, the solar cell 14 may include an outer ledge that enables the solar cell to rest on top of the top cap 32. The solar cell 14 may be unsecured or may be secured with suitable fastenings including studs, screws, adhesives, etc.

The top cap 32 is retained to the upper ring 36 by one or more screws or bolts 37 that extend from a lower surface of the top cap 32 and pass through apertures in the upper ring 36. Nuts 38 may be used on the screws 37 to fasten the upper ring 36 to the top cap 32. The screws 37 may pass through apertures in an upper plate 39. The upper plate 39 may have a recess in the underside surface that receives the upper ring 36. The upper plate 39 may thus conceal the upper ring 36 and the junction of the upper ring 36 with the second lens 18 when the upper housing is assembled. The upper plate 39 may have a shape or profile designed to enhance the aesthetic appearance of the lighting device 10 and may have a similar shape, size and/or color to the base plate 29 of the lower housing portion 20.

FIG. 3 shows an assembled lighting device 10 in side view while FIG. 4 shows the assembled lighting device in perspective view. In these views, it can be seen that the second lens 18 surrounds the light source 12 and first lens 16 in all horizontal directions, i.e. on all four sides of the generally square shaped lighting device 10. While the lighting device 10 is shown as generally square, other shapes may be designed including round, rectangular, octagonal, hexagonal, etc.

The lighting device 10 may include a reflector 40. The reflector 40 is generally pyramidal in shape and includes faces 41 which may be straight or curved, e.g. concave, and a lower base edge 42 that rests on the lower ring 22 such that the reflector is disposed at the lower open end of the second lens 18. In one embodiment, the internal profile of the lower ring 22 may include a recess that is sized and shaped to receive the reflector 40. The reflector 40 may include additional fastening to the lower ring, e.g. via screws, press tabs, etc. The outer surface of the reflector 43 may have a curving shape, the slope of which may increase traversing from the outer edge 44 towards the center 45. In one embodiment, the curve may be parabolic. The reflector 40 is disposed generally beneath the light source 12 and first lens 16 so that downward heading light from the first lens 16 is reflected away from the lower open end of the reflector and outwards towards the surrounding side walls of the second lens 18 towards viewers, thereby creating a brighter appearance.

The lens components may be made from poly carbonate, plastic, glass or similar and the opaque and reflective parts may be made from Acrylonitrile butadiene styrene (ABS) with appropriate paints, coatings or platings as required, e.g. to provide reflective surfaces. The base 29 and the upper plate 39 can be made from many different things, including metal plated plastic and wood as determined primarily by the aesthetic requirements of the lighting device.

The lighting device may be post mounted, hung or otherwise displayed. For example, the lower portion of the housing may include one or more slots of apertures that are sized and shaped to receive a post 49 (FIG. 2). As a viewer walks around the light, the viewer sees an enhanced visual effect, including sparkles and shimmers.

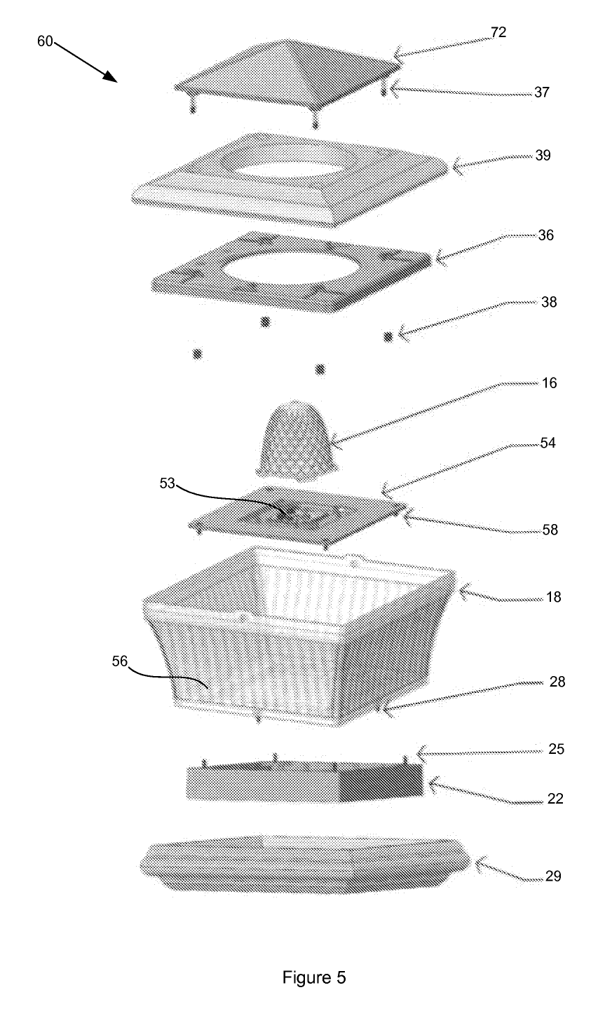

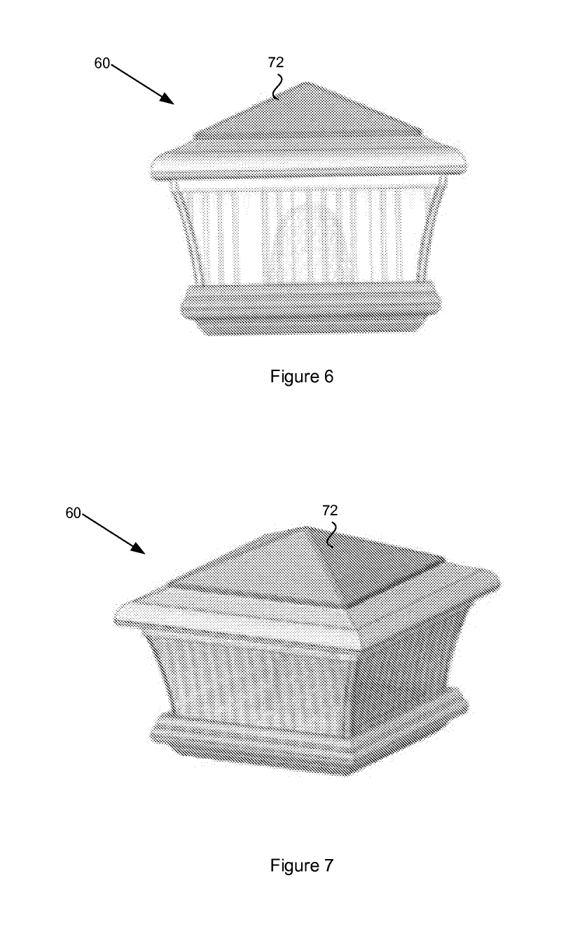

FIGS. 5-7 depict an alternative embodiment 60 in which the solar powered light source 12 and solar panel 19 are replaced with an externally powered light source assembly that is powered from an external power source (not shown). In this embodiment, the light source assembly includes one or more LEDs, bulbs or similar light elements 53 that connect to an attachment plate 54 that includes the electronics required for powering the light elements 53. The first dome lens 16 is shown inverted with respect to the embodiment of FIGS. 1-4 and rests on the attachment plate 54. Positive engagement between the dome lens 16 and attachment plate 54 may be provided by a bayonet fitting, détentes, press tabs, screw threads, etc. Wires (not shown) may connect from the external power supply to the light elements 53 and/or associated electronics through apertures in the attachment plate 53.

The lower ring 22 may be adapted with recesses and edges within the confines of the peripheral wall that receive the attachment plate 54. The attachment plate may be further affixed to the lower ring 22 by screws 58, press tabs, etc. In one embodiment, the attachment plate 54 may have the same dimensions as the reflector 40 to enable the same lower ring 22 to be used for either embodiment. In one embodiment, the second lens 18 may include lower horizontal components 56 (visible through the side wall of second lens 18) that may be sandwiched between the attachment plate 54 and the lower ring 22

The upper housing portion 70 of the embodiment of FIGS. 4-6 may also be modified such that a pyramidal top cap 72 is utilized in place of the solar panel 19 and top cap 32. The pyramidal top cap 72 may be affixed to the upper ring 36 through the upper plate 39 similar to the embodiments of FIGS. 1-4. An underside surface of the top cap 72 may have a curved surface, e.g. parabolic, to act as a reflector that is disposed above the light source 53 and dome lens 16 in order to reflect light away from the upper open end of the second lens 18 and toward the surrounding side walls of the second lens 18.

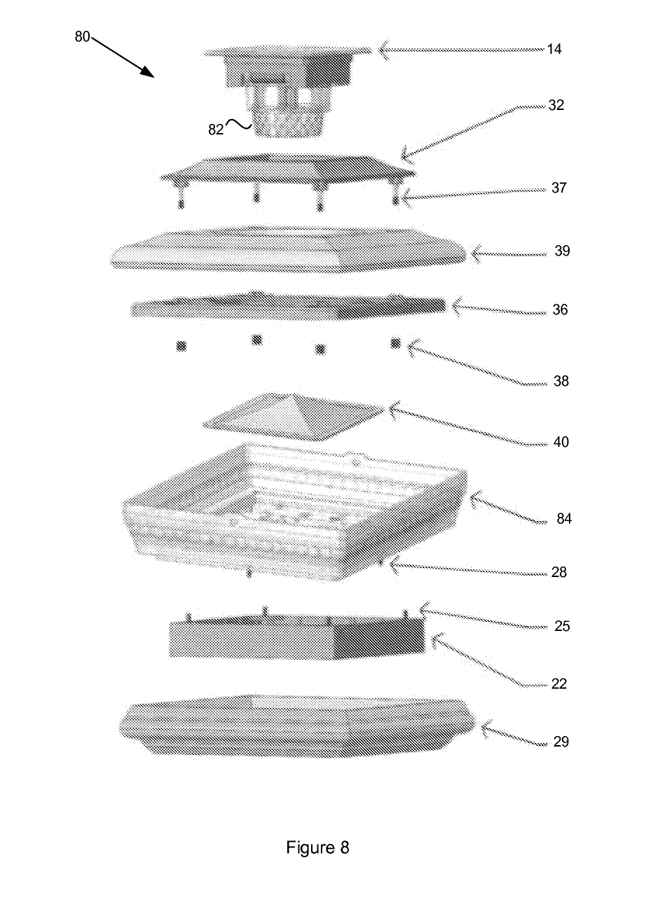

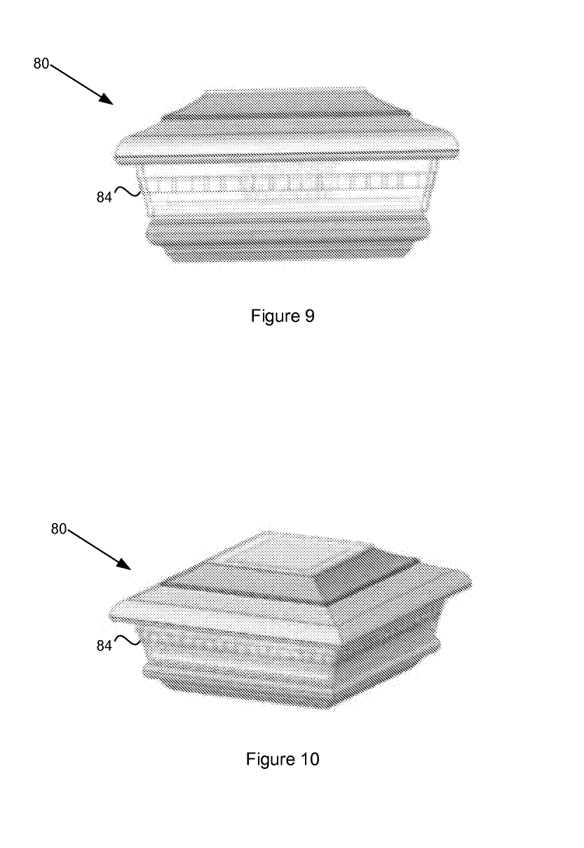

FIGS. 8-10 show a second alternative embodiment 80 which includes an alternative first lens arrangement 82 that is generally circular and surrounds the light source within the lens 82. The light source is powered by a solar panel arrangement in a similar manner to the embodiment of FIGS. 1-4 described above. The second lens 84 is depicted as having a reduced height compared to the embodiments of FIGS. 1-7. Otherwise, the construction of the upper and lower housing portions and the reflector 40 is substantially similar to the embodiments of FIGS. 1-3.

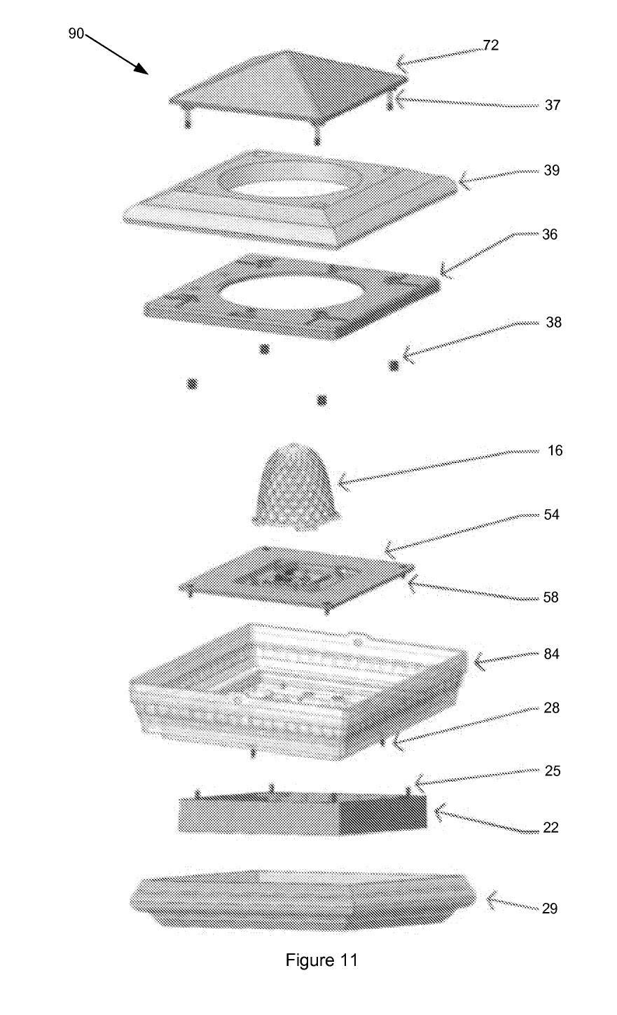

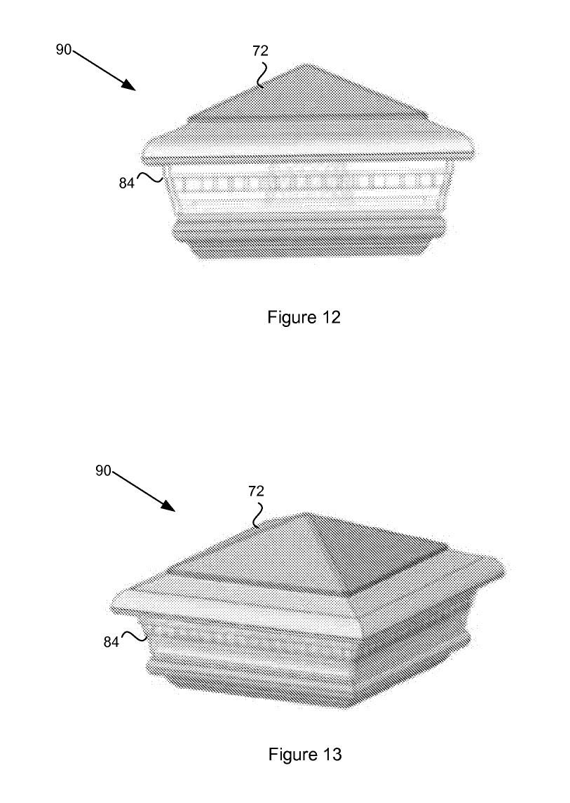

FIGS. 11-13 depict a third alternative embodiment 90 in which the housing of the embodiment of FIGS. 8-10 which accommodates a solar panel arrangement is modified to accommodate an externally powered light source arrangement, similar to the embodiment of FIGS. 5-7.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A post cap light comprising:
(A) a light source;
(B) a first lens covering the light source;
(C) a second lens around the first lens;
(D) a housing that provides support to at least the second lens.

2. The post cap light of claim 1 comprising a reflector.

3. The post cap light of claim 2 wherein the reflector has a pyramidal reflecting surface.

4. The post cap light of claim 3 wherein one or more sides of the pyramid are curved.

5. The post cap light of claim 3 wherein the second lens surrounds the sides of the first lens and wherein the reflector is disposed below the light source to at least partially reflect light from the light source towards the second lens.

6. The post cap light of claim 1 wherein the first lens provides a first lighting effect to alter light passing from the light source through the first lens.

7. The post cap light of claim 6 wherein the second lens provides a second lighting effect to alter light passing from the first lens through the second lens, wherein the first lighting effect is different to the second lighting effect.

8. The post cap light of claim 1 comprising a power source assembly comprising at least one solar panel that electrically connects to the light source.

9. The post cap light of claim 8 wherein the power source assembly supports the first lens below the power source.

10. The post cap light of claim 8 wherein the housing comprises:
(A) an upper housing assembly comprising a top cap;
(B) an aperture defined by an inner rim of the top cap;
(C) wherein the top cap supports the power source assembly such that the solar panel is exposed above the housing and such that the light source and first lens extend through the aperture to below the top cap.

11. The post cap light of claim 10 wherein the housing comprises a lower housing assembly that supports the second lens and wherein the second lens supports the upper housing assembly.

12. The post cap light of claim 11 wherein the lower housing assembly supports a reflector below the first lens.

13. The post cap light of claim 11 wherein the lower housing assembly comprises:
(A) a base ring that supports the second lens; and
(B) a base plate that supports the base ring and conceals a junction of the base ring and the second lens.

14. A post cap light comprising:
(A) light source means for providing light;
(B) first lens means for providing a first lighting effect to light from the light source means;
(C) second lens means for providing a second lighting effect to light from the light source means; and
(D) housing means for supporting at least the second lens means.

15. The post cap light of claim 14 comprising reflector means for reflecting light from the first lens means toward the second lens means.

16. The post cap light of claim 14 comprising power source means for providing power to the light source means.

17. The post cap light of claim 16 wherein the housing means supports the power source means.

18. The post cap light of claim 14 wherein the housing means comprises first lower housing means for supporting the second lens means and second lower housing means for concealing a junction of the first lower housing means and the second lens means.

19. The post cap light of claim 18 wherein the first lower housing means supports reflector means.

20. A post cap light comprising:
(A) a light source;
(B) a first lens covering the light source, the first lens comprising one of a faceted lens or a lens comprising one or more grooves, ridges or flutes;
(C) a second lens around the first lens, the second lens comprising the other of a faceted lens or a lens comprising one or more grooves, ridges or flutes;
(D) a housing that provides support to at least the second lens; and
(E) a post for supporting the housing.
